(19) United States
(12) Patent Application Publication
(10) Pub. No.: US 2008/0026105 A1
(43) Pub. Date: Jan. 31, 2008

(54) Nutritional formulations containing octenyl succinate anhydride-modified tapioca starch

(75) Inventors: Khaled A. Khatib, Newburgh, IN (US); Win-Chin Chiang, Newburgh, IN (US); Rosanne P. Batema, Evansville, IN (US)

Correspondence Address: BRISTOL-MYERS SQUIBB COMPANY - MEAD JOHNSON, 2400 WEST LLOYD EXPRESSWAY, PATENT DEPARTMENT, EVANSVILLE, IN, 47721, US

(73) Assignee: BRISTOL-MYERS SQUIBB COMPANY, PRINCETON, NJ (US)

(21) Appl. No.: 11/494,970

(22) Filed: Jul. 28, 2006

(51) Int. Cl. A23L 1/30

(52) U.S. Cl. 426/72; 426/656; 426/658

(57) ABSTRACT

The present invention relates to a nutritional formulation comprising a lipid source, a carbohydrate source, a protein equivalent source, and an emulsifying agent comprising OSA-modified tapioca starch which contains less than about 0.05% non-protein nitrogen.

### BACKGROUND OF THE INVENTION

(1) Field of the Invention

The present invention relates generally to nutritional formulations.

(2) Description of the Related Art

Food allergy is an immunologically mediated clinical syndrome that may develop after the ingestion of a dietary product. The adverse reaction that accompanies a food allergy is often an immediate immunoglobulin-E mediated reaction, otherwise known as a food protein allergy. Host, A., et al., Dietary Products Used in Infants for Treatment and Prevention of Food Allergy, Arch. Dis. Child 81:80-84 (1999). Symptoms of food protein allergy include angioedema, urticaria, exzema, asthma, rhinitis, conjunctivitis, vomiting, and anaphylaxis.

Cow's milk allergy is the most common food protein allergy in young children and occurs in about 2% to 3% of all infants. Sampson, H. A., Food Allergy. Part 1: Immunopathogenesis and Clinical Disorders, J Allergy Clin Immunol. 103:717-728 (1999). The cow's milk protein used in most formulas is considered a foreign protein. When infants are exposed to non-human milk, they can develop antibodies to the foreign protein. Research has shown that the important food allergens found in both milk and soybean formulas are stable to digestion in the stomach for as long as 60 minutes (as compared to human milk protein which is digested in the stomach within 15 minutes). The foreign proteins then pass through the stomach and reach the intestines intact, where they gain access and can cause sensitization. The infant's immune system then “attacks” the foreign proteins, resulting in symptoms of an allergic reaction.

One possible explanation for the prevalence of protein allergies among infants is that intact cow's milk protein, which is found in most conventional infant formulas, is the earliest and most common food allergen to which infants are exposed. In fact, about 80% of formulas on the market are cow's milk-based.

In recent years, both infant formulas and children's nutritional products have been designed to try to reduce the incidence of protein allergies. One such example involves the use of hydrolyzed cow milk. Typically, the proteins in extensively hydrolyzed formulas have been treated with enzymes to break down some or most of the proteins that cause adverse symptoms with the goal of reducing allergic reactions, intolerance, and sensitization.

While protein hydrolysates are less allergenic, they are not completely allergen-free. Halken S. et al., The Effect of Hypoallergenic Formulas in Infants at Risk of Allergic Disease, Eur. J. Clin. Nutr. 49(S1):S77-S83 (1995). Further, the new protein structures created by the enzymes in hydrolyzed formulas may actually provoke an allergic response. Hudson M. J., Product Development Horizons—A View from Industry, Eur. J. Clin. Nutr. 49(S1):S64-S70 (1995). In fact, among children who are allergic to cow's milk, almost 10% are also sensitive to protein hydrolysate formulas. Giampietro P. G., et al., Hypoallergenicity of an Extensively Hydrolyzed Whey Formula, Pediatr. Allergy Immunol. 12:83-86 (2001).

Another alternative to cow's milk is a soy protein-based product. Unfortunately, however, soy protein can also cause allergies or intolerance reactions. In fact, about 8% to 14% of infants who are allergic to cow's milk are also allergic to the protein in soy formulas. Zeiger R. F., et al., Soy Allergy in Infants and Children with IgE-Mediated Cow Milk Allergy, J. Pediatr. 134:614-622 (1999). Infants with a previous history of cow's milk protein allergy or intolerance have a greater risk of developing soy protein allergy or intolerance, possibly due to the damage to the intestinal mucosa caused by cow milk proteins. This damage may allow an increased uptake of soy proteins, precipitating further reactions and symptoms.

Thus, for infants and children that have allergic reactions to hydrolyzed or soy-based formulas, a nutritional formulation based on amino acids is often the solution. Amino acids are the basic structural building units of protein. Breaking the proteins down to their basic chemical structure (completely pre-digested) makes amino acid-based formulas the most hypoallergenic formulas available. Several commercially available amino acid based-formulas and nutritional supplements include Neocate®, L-Emental™, and Vivonex® Plus.

For the infant or child that has multiple food protein intolerances or allergies, the amino acid-based formula should also avoid any constituents that may add protein into the formula. A variety of conventional emulsifiers, however, which are added to the formula to ensure that it remains homogenous and does not separate, contain levels of protein that may be allergenic to a sensitized individual. From the foregoing, it can be seen that a need exists for a nutritional formulation which provides an effective emulsification and does not introduce potentially allergenic levels of protein into the formulation via the emulsifying agent.

### SUMMARY OF THE INVENTION

Briefly, an embodiment of the invention is directed to a novel nutritional formulation comprising a lipid source, a carbohydrate source, a protein equivalent source, and an emulsifying agent comprising octenyl succinate anhydride (OSA)-modified tapioca starch which contains less than about 0.05% non-protein nitrogen.

Other embodiments of the invention are directed to a reconstituted nutritional formulation comprising a lipid source, a carbohydrate source, a protein equivalent source, and about 5% of an emulsifying agent comprising OSA-modified tapioca starch wherein the reconstituted nutritional formulation contains less than about 5 ppm non-protein nitrogen.

### DETAILED DESCRIPTION OF SEVERAL EMBODIMENTS

Reference now will be made in detail to the embodiments of the invention, one or more examples of which are set forth below. Each example is provided by way of explanation of the invention, not a limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment.

Thus, it is intended that the present invention covers such modifications and variations as come within the scope of the appended claims and their equivalents. Other objects, features and aspects of the present invention are disclosed in, or are obvious from, the following detailed description. It is to be understood by one of ordinary skill in the art that the present discussion is a description of exemplary embodiments only, and is not intended as limiting the broader aspects of the present invention.

The term “infant”, as used in the present application, means a postnatal human that is less than about 1 year of age.

The terms “child” or “children” mean a postnatal human that is between the ages of about 1 year and 10 years.

As used herein, the terms “infant formula” mean a composition that satisfies the nutrient requirements of an infant by being a substitute for human milk.

The terms “nutritional formulation” mean any composition that either satisfies the nutrient requirements of a subject or supplements the diet of a subject.

The terms “protein equivalent” can comprise any protein source, such as soy, egg, whey, or casein, as well as non-protein sources such as amino acids.

The terms “protein-free” mean containing no measurable amount of protein, as measured by standard protein detection methods such as sodium dodecyl (lauryl) sulfate-polyacrylamide gel electrophoresis (SDS-PAGE) or size exclusion chromatography.

As used herein, the terms “partially hydrolyzed” mean a degree of hydrolysis which is greater than about 0% but less than about 50%.

The terms “extensively hydrolyzed” mean a degree of hydrolysis which is greater than or equal to about 50%.

The term “allergy” refers to hypersensitivity reactions of the immune system to specific allergens that may result in adverse symptoms.

The term “intolerance”, as used herein, relates to particular adverse effects that occur after eating a substance, but which do not involve the immune system. For example, food intolerances may occur because the digestive system does not produce sufficient quantities of a particular enzyme or chemical which is needed to break down food and aid in digestion.

In an embodiment, the invention is directed to a novel nutritional formulation comprising a lipid source, a carbohydrate source, a protein equivalent source, and an emulsifying agent comprising OSA-modified tapioca starch which contains less than about 0.05% non-protein nitrogen.

In an embodiment, the nutritional formulation can be protein-free. The nutritional formulation can be an infant formula or a children's nutritional product. The infant formula of the invention can be a term infant formula or a preterm infant formula. In some embodiments, the nutritional formulation for use in the present invention is nutritionally complete and contains suitable types and amounts of free amino acids, lipids, carbohydrates, vitamins and minerals.

In a particular embodiment of the invention, the protein equivalent source is 100% free amino acids. In this embodiment, the nutritional formulation is allergen-free. The amount of free amino acids in the nutritional formulation can typically vary from about 1 to about 5 g/100 kcal. In an embodiment, 100% of the free amino acids have a molecular weight of less than 500 Daltons.

In other embodiments, the protein equivalent source can comprise soy protein, whey protein, casein protein, or egg protein. The protein can be intact, partially hydrolyzed, or extensively hydrolyzed.

Another component of the nutritional formulation of the invention is a lipid source. The amount of lipid can typically vary from about 3 to about 7 g/100 kcal. Lipid sources can be any known or used in the art, e.g., vegetable oils such as palm oil, canola oil, corn oil, soybean oil, palmolein, coconut oil, medium chain triglyceride oil, high oleic sunflower oil, high oleic safflower oil, and the like.

Yet another component of the nutritional formulation is a carbohydrate source. The amount of carbohydrate typically can vary from about 8 to about 12 g/100 kcal. Carbohydrate sources can be any known or used in the art, e.g., lactose, glucose, corn syrup solids, maltodextrins, sucrose, rice syrup solids, and the like.

The nutritional formulation of the present invention can also contain an emulsifying agent comprising OSA-modified tapioca starch. In some embodiments, the OSA-modified tapioca starch contains less than about 0.10% non-protein nitrogen. In other embodiments, the OSA-modified tapioca starch contains less than about 0.05% non-protein nitrogen. In certain embodiments of the invention the OSA-modified tapioca starch can contain less than about 0.045% non-protein nitrogen. In particular embodiments, the OSA-modified tapioca starch can contain less than about 0.04% non-protein nitrogen. In some embodiments, the OSA-modified tapioca starch is protein-free.

The OSA-modified tapioca starch can be intact or dextrinized. In certain embodiments, the level of OSA-modified tapioca starch in the invention can be in the range of about 2% to about 15%. In other embodiments, the level of OSA-modified tapioca starch in the invention can be in the range of about 3% to about 10%. In further embodiments of the invention, the OSA-modified tapioca starch can be in the range of about 5% to about 15%. In a particular embodiment of the invention, the level of OSA-modified tapioca starch can be about 5%.

In certain embodiments of the invention, the tapioca starch is harvested from a cassaya or monioc plant (Manihot utilissima). The shrub typically grows to be 2 to 3 meters in height, has woody stems, and has swollen tuberous roots. From these roots, tapioca starch is prepared. Tapioca starch falls into two main categories: bitter (Manihot palmata) and sweet (Manihot aipi). The tapioca starch of the present invention may be bitter or sweet. In a particular embodiment, the tapioca starch is of the bitter variety.

In an embodiment, the OSA-modified tapioca starch is NATIONAL 78-0701, manufactured by National Starch & Chemical Company. As measured using SDS-PAGE methodologies, this starch does not contain any measurable amount of protein. Using a LECO 2000 CNS analyzer (LECO Corporation, St. Joseph, Mich., USA) and combustion methodologies, the NATIONAL 78-0701 OSA-modified tapioca starch was determined to contain less than about 0.05% non-protein nitrogen.

The OSA-modified tapioca starch used in the present invention can contain between about 10% to 20% amylose and between about 80% to 90% amylopectin. In a particular embodiment, the OSA-modified tapioca starch may contain about 13% amylose and about 87% amylopectin.

The OSA-modified tapioca starch used in the present invention is characterized by excellent emulsion stabilizing and encapsulating ability. It forms strong films at the oil/water interface, giving the emulsion resistance to re-agglomeration. Though not wishing to be bound by this or any theory, it is believed that the OSA-modified tapioca starch used in the present invention is a stabilizer with molecules that consist of hydrophilic and hydrophobic (lipophilic) parts. The hydrophobic portion of the emulsifier comprises OSA while the hydrophilic portion of the emulsifier comprises tapioca starch.

It is believed that the ability of OSA-modified tapioca starch to stabilize oil/water emulsions is linked to the starch being gelatinized or heated to ensure the starch disperses well enough in the water phase to have a stabilizing effect at the oil-water interface. It allows precise control of thickening in low-viscosity food systems where starch previously could not be used. It has excellent dispersability and stability. This starch is additionally resistant to heat, acid, and moderate to high shear forces. The use of the starch in nutritional formulations additionally provides creaminess to the formula itself.

In the embodiment in which the level of OSA-modified tapioca starch is about 5%, the starch contributes about 4% of the total calories (expressed as 100 kcal) to the nutritional formulation. In certain embodiments of the invention, OSA-modified tapioca starch is the sole emulsifier and stabilizer in the nutritional formulation.

In certain embodiments, the nutritional formulation of the invention is hypoallergenic. In other embodiments, the nutritional formulation is kosher. In still further embodiments, the nutritional formulation is a non-genetically modified product. In an embodiment the nutritional formulation is sucrose-free. The nutritional formulation may additionally be lactose-free. In other embodiments the nutritional formulation does not contain any medium-chain triglyceride oil. In some embodiments, no carrageenan is present in the nutritional formulation. In yet other embodiments, the nutritional formulation is free of all gums.

In some embodiments of the invention the pH of the nutritional formulation is between about 3 and 8. In other embodiments, the pH of the nutritional formulation is between about 6 and 7. In particular embodiments, the pH of the nutritional formulation is between about 5 and 6. In yet other embodiments, the pH of the nutritional formulation is between about 4 and 5. In a specific embodiment, the pH of the nutritional formulation is about 4.8. In other embodiments, the pH of the nutritional formulation is about 5.5. If still other embodiments, the pH of the nutritional formulation is about 6.5.

In certain embodiments, the viscosity of the reconstituted nutritional formulation can be between about 3.0 and 4.0 centipoise (cps) at 72° F. In other embodiments, the viscosity of the reconstituted nutritional formulation can be between about 3.2 and 3.6 cps at 72° F. In yet other embodiments, the viscosity of the reconstituted nutritional formulation can be about 3.4 cps at 72° F.

The nutritional formulation of the invention can be a liquid (ready-to-use or concentrated) or powder. If the nutritional formulation is a liquid, the shelf life of the nutritional formulation is at least 18 months. If the nutritional formulation is a powder, the shelf life of the nutritional formulation is at least 24 months.

In some embodiments of the invention, the reconstituted nutritional formulation contains less than about 10 ppm non-protein nitrogen. In other embodiments, the reconstituted nutritional formulation contains less than about 7 ppm non-protein nitrogen. In still other embodiments, the reconstituted nutritional formulation contains less than about 5 ppm non-protein nitrogen. In a particular embodiment, the reconstituted nutritional formulation contains about 3.4 ppm non-protein nitrogen. In another embodiment, the reconstituted nutritional formulation contains about 2.97 ppm non-protein nitrogen.

It is to be understood that the total amount of non-protein nitrogen in the reconstituted formulation depends on the amount of non-protein nitrogen in the OSA-modified tapioca starch as well as the amount of OSA-tapioca starch present in the nutritional formulation. Accordingly, combinations of these two factors which results in a total ppm as recited above are encompassed within the present invention.

In an embodiment, the invention can comprise a method for treating an infant or child that has food protein intolerances or allergies. The method comprises feeding the nutritional formulation of the invention to the infant or child. In some embodiments, the infant or child is in need of such treatment. The terms “in need” can mean that the infant or child is at risk for developing an intolerance or allergy. An infant or child may be at risk if there is a strong family history of allergy, or may be at risk due to diet, disease, trauma, or physical disorder. In some embodiments, feeding the nutritional formulation of the present invention to an infant having multiple food protein intolerances or allergies may prevent future occurrences of allergic reactions.

DHA and ARA are long chain polyunsaturated fatty acids (LCPUFAs) which have previously been shown to contribute to the health and growth of infants and children. DHA and ARA are typically obtained through breast milk in infants that are breast-fed. In infants that are formula-fed, however, DHA and ARA must be supplemented into the diet. In some embodiments of the present invention, the nutritional formulation contains DHA. In some embodiments of the present invention, the nutritional formulation contains DHA and ARA.

In an embodiment of the invention, the weight ratio of ARA:DHA ranges from about 10:1 to about 1:10. In another embodiment of the present invention, this ratio ranges from about 5:1 to about 1:5. In yet another embodiment, the ratio ranges from about 3:1 to about 1:3. In one particular embodiment the ratio ranges about 3:1 to about 1:2. In another particular embodiment of the invention, the ratio is about 2:1.

In certain embodiments of the invention, the level of DHA is between about 0.20% and 0.50% of fatty acids. In other embodiments of the invention the level of DHA is about 0.35% of fatty acids. In yet other embodiments of the invention, the level of ARA is between 0.60% and 0.80% of fatty acids. In a particular embodiment, the level of ARA is about 0.72% of fatty acids. In some embodiments of the invention, only DHA is supplemented into the formulation.

The amount of DHA in an embodiment of the present invention can be from about 3 mg per kg of body weight per day to about 150 mg per kg of body weight per day. In one embodiment of the invention, the amount is from about 6 mg per kg of body weight per day to about 100 mg per kg of body weight per day. In another embodiment the amount is from about 15 mg per kg of body weight per day to about 60 mg per kg of body weight per day.

The amount of ARA in an embodiment of the present invention can be from about 5 mg per kg of body weight per day to about 150 mg per kg of body weight per day. In one embodiment of this invention, the amount varies from about 10 mg per kg of body weight per day to about 120 mg per kg of body weight per day. In another embodiment, the amount varies from about 15 mg per kg of body weight per day to about 90 mg per kg of body weight per day. In yet another embodiment, the amount varies from about 20 mg per kg of body weight per day to about 60 mg per kg of body weight per day.

The amount of DHA in nutritional formulations for use in an embodiment of the present invention can be from about 2 mg/100 kilocalories (kcal) to about 100 mg/100 kcal. In another embodiment, the amount of DHA varies from about 5 mg/100 kcal to about 75 mg/100 kcal. In yet another embodiment, the amount of DHA varies from about 15 mg/100 kcal to about 60 mg/100 kcal.

The amount of ARA in nutritional formulations for use in an embodiment of the present invention can be from about 4 mg/100 kcal to about 100 mg/100 kcal. In another embodiment, the amount of ARA varies from about 10 mg/100 kcal to about 67 mg/100 kcal. In yet another embodiment, the amount of ARA varies from about 20 mg/100 kcal to about 50 mg/100 kcal. In a particular embodiment, the amount of ARA varies from about 30 mg/100 kcal to about 40 mg/100 kcal.

The nutritional formulation supplemented with oils containing DHA and ARA for use in the present invention can be made using standard techniques known in the art. For example, an equivalent amount of an oil which is normally present in a nutritional formulation, such as high oleic sunflower oil, may be replaced with DHA and ARA.

The source of the ARA and DHA can be any source known in the art such as fish oil, single cell oil, egg yolk lipid, brain lipid, and the like. The DHA and ARA can be in natural form, provided that the remainder of the LCPUFA source does not result in any substantial deleterious effect on the infant. Alternatively, the DHA and ARA can be used in refined form.

Sources of DHA and ARA may be single cell oils as taught in U.S. Pat. Nos. 5,374,657, 5,550,156, and 5,397,591, the disclosures of which are incorporated herein by reference in their entirety.

In some embodiments of the invention, DHA is sourced from single cell oils. In another embodiment of the invention, ARA is sourced from single cell oils. In particular embodiments, both DHA and ARA are sourced from single cell oils.

The LCPUFA source may or may not contain eicosapentaenoic acid (EPA). In some embodiments, the LCPUFA used in the invention contains little or no EPA. For example, in certain embodiments the nutritional formulations contain less than about 20 mg/100 kcal EPA; in some embodiments less than about 10 mg/100 kcal EPA; in other embodiments less than about 5 mg/100 kcal EPA; and in still other embodiments substantially no EPA.

In certain embodiments, the OSA-modified tapioca starch having a non-protein nitrogen content of less than about 0.05% could be added to a standard infant formula, a hydrolyzed protein infant formula, a lactose-free infant formula, a soy protein infant formula, a hydrolyzed soy protein infant formula, any nutritional formulation which requires additional viscosity, or any nutritional formulation which requires a stronger emulsion. For example, the OSA-modified tapioca starch having a non-protein nitrogen content of less than about 0.05% could be added to Enfamil®, Enfamil® Premature Formula, Enfamil® with Iron, Lactofree®, Nutramigen®, Pregestimil®, Lipil® or ProSobee® (available from Mead Johnson & Company, Evansville, Ind., U.S.A.). The OSA-modified tapioca starch having a non-protein nitrogen content of less than about 0.05% could also be added to various infant, children and adult nutritional products.

The following examples describe various embodiments of the present invention. Other embodiments within the scope of the claims herein will be apparent to one skilled in the art from consideration of the specification or practice of the invention as disclosed herein. It is intended that the specification, together with the examples, be considered to be exemplary only, with the scope and spirit of the invention being indicated by the claims which follow the examples. In the examples, all percentages are given on a weight basis unless otherwise indicated.

### EXAMPLE 1

This example illustrates one embodiment of a nutritional formulation of the present invention. Table 1 illustrates the ingredients present in an embodiment of the present powdered nutritional supplement and their amounts in grams (g) or kilograms (kg), expressed per 100 kg nutritional supplement.

TABLE 1
Ingredient Information and Concentrations (Per 100 kg)

| Ingredient, Unit | Per 100 kg |
|---|---|
| Amino Acid Powder Base, kg | 64.992 |
| Corn Syrup Solids, kg | 29.169 |
| Fat Blend, Bulk, kg | 25.926 |
| Palm Olein Oil, kg | 11.667 |
| Soybean Oil, kg | 5.185 |
| Coconut Oil, kg | 5.185 |
| High Oleic Sunflower Oil, kg | 3.889 |
| Calcium Phosphate Dibasic, kg | 1.600 |
| Potassium Citrate, kg | 0.333 |
| Single Cell ARA and DHA, kg | 0.724 |
| OSA-modified Tapioca Starch, kg | 5.000 |
| Calcium Citrate, kg | 0.330 |
| Sodium Citrate Dihydrate Granular, | 0.273 |
| kg | |
| Potassium Chloride, kg | 0.189 |
| Choline Chloride, kg | 0.196 |
| Magnesium Oxide, Light, kg | 0.091 |
| Calcium Hydroxide, kg | 0.147 |
| L-Carnitine, g | 14.398 |
| Sodium Iodide, g | 0.095 |
| Corn Syrup Solids, kg | 14.540 |
| Essential Amino Acid Premix, kg | 9.8 |
| L-Leucine, kg | 1.736 |
| Lysine Hydrochloride, kg | 1.408 |
| L-Valine, kg | 1.068 |
| L-Isoleucine, kg | 0.956 |
| Corn Syrup Solids, kg | 0.890 |
| L-Threonine, kg | 0.864 |
| L-Tyrosine, kg | 0.765 |
| L-Phenylalanine, kg | 0.708 |
| L-Histidine, kg | 0.371 |
| L-Cystine, kg | 0.371 |
| L-Tryptophan, kg | 0.337 |
| L-Methionine, kg | 0.326 |
| Non-Essential Amino Acid Premix, | 9.8 |
| kg | |
| L-Aspartic Acid, kg | 2.822 |
| L-Proline, kg | 1.406 |
| L-Alanine, kg | 1.375 |
| Corn Syrup Solids, kg | 1.249 |
| Monosodium Glutamate, kg | 0.967 |
| L-Serine, kg | 0.865 |
| L-Arginine, kg | 0.745 |
| Glycine, kg | 0.371 |
| Dry Vitamin Premix, kg | 0.403 |
| Ascorbic Acid, g | 149.352 |
| Inositol, g | 99.541 |
| Corn Syrup Solids, Low Sodium, | 62.377 |
| DE 24, g | |
| Taurine, g | 35.343 |
| Tocopheryl Acetate, Dry, g | 25.792 |
| Vitamin A Beadlets, g | 7.967 |
| Niacinamide, g | 6.416 |
| Vitamin K1, Dry 1%, g | 5.078 |
| Calcium Pantothenate, g | 3.982 |
| Vitamin B12, 0.1% in starch, g | 2.337 |
| Biotin Trituration 1%, g | 2.176 |
| Vitamin D3 Powder, g | 0.850 |
| Thiamine Hydrochloride, g | 0.633 |
| Riboflavin, g | 0.580 |
| Pyridoxine Hydrochloride, g | 0.455 |
| Folic Acid, g | 0.121 |
| Trace/Ultratrace Mineral Premix | 0.235 |
| for Amino Acid Formula, kg | |
| Corn Syrup Solids, g | 218.818 |
| Zinc Sulfate, Monohydrate, g | 14.126 |
| Sodium Selenite, g | 7.050 |
| Cupric Sulfate, Powder, g | 0.035 |
| (CuSO45H20) | |
| Manganese Sulfate, Monohydrate, g | 1.692 |
| Iron Trituration, kg | 0.230 |
| Corn Syrup Solids, g | 178.238 |
| Ferrous Sulfate, g | 46.00 |
| Ascorbic Acid, g | 5.762 |

Table 2 illustrates the concentration of relevant components in the nutritional formulation of Example 1.

TABLE 2
Component Concentrations

| | Per 100 g | |
|---|---|---|
| Component, Unit | Powder | Per 100 mL |
| Protein Equivalent, g | 14.34 | 1.95 |
| Lipid, g | 26.67 | 3.63 |
| Carbohydrate, g | 53.82 | 7.32 |
| Ash, g | 2.78 | 0.38 |
| Moisture, g | 2.39 | |
| Calories, kcal | 510 | 69.3 |

The caloric distribution of the nutritional formulation of Example 1 is depicted in Table 3.

TABLE 3
Caloric Distribution

| Component | Caloric Percentages |
|---|---|
| Protein Equivalent | 11.12% |
| Lipid | 47.36% |
| Carbohydrate | 41.52% |

### EXAMPLE 2

This example illustrates another embodiment of a nutritional formulation of the present invention. Table 4 illustrates the nutrients present in an embodiment of the present nutritional supplement and their amounts expressed per 100 Calories.

TABLE 4
Nutrients

| | Per 100 Calories |
|---|---|
| (Normal Dilution) | (5 fl oz) |
| Protein, g | 2.8 |
| Fat, g | 5.3 |
| Linoleic acid, mg | 1040 |
| DHA, mg | 17 |
| ARA, mg | 34 |
| Carbohydrate, g | 10.3 |
| Water, g | 133 |
| Vitamin A, IU | 300 |
| Vitamin D, IU | 50 |
| Vitamin E, IU | 2 |
| Vitamin K, μg | 8 |
| Thiamin (Vitamin B1), μg | 80 |
| Riboflavin (Vitamin B2), μg | 90 |
| Vitamin B6, μg | 60 |
| Vitamin B12, μg | 0.3 |
| Niacin, μg | 1000 |
| Folic acid (folacin), μg | 16 |
| Pantothenic acid, μg | 500 |
| Biotin, μg | 3 |
| Vitamin C (ascorbic acid), mg | 12 |
| Choline, mg | 24 |
| Inositol, mg | 17 |
| Carnitine, mg | 2 |
| Taurine, mg | 6 |
| Calcium, mg | 94 |
| Phosphorus, mg | 52 |
| Magnesium, mg | 11 |
| Iron, mg | 1.8 |
| Zinc, mg | 1 |
| Manganese, μg | 25 |
| Copper, μg | 75 |
| Iodine, μg | 15 |
| Selenium, μg | 2.8 |
| Sodium, mg | 47 |
| Potassium, mg | 110 |
| Chloride, mg | 86 |

Table 5 illustrates the nutrient density, per 20 Calories/fl oz, of relevant components in the nutritional formulation of Example 2.

TABLE 5
Nutrient Density

| | 20 Calories/fl |
|---|---|
| | oz |
| Protein (% Calories) | 11 |
| Fat (% Calories) | 47 |
| Carbohydrate (% Calories) | 42 |
| Potential Renal Solute Load (mOsm/100 | 25 |
| Calories)† | |
| Potential Renal Solute Load (mOsm/100 mL)† | 16.8 |
| Osmolality (mOsm/kg water) | 320 (Liquid) |
| | 300 (Powder) |
| Osmolarity (mOsm/L) | 290 (Liquid) |
| | 270 (Powder) |

### EXAMPLE 3

This example illustrates another embodiment of a nutritional formulation of the present invention. Table 6 illustrates the nutrients present in an embodiment of the present liquid nutritional supplement and their amounts expressed per 100 Calories.

TABLE 6
Nutrients
Table 6: Nutrients

| | Per 100 Calories | | |
|---|---|---|---|
| | | 20 | 24 |
| | 20 | Calories/ | Calories/ |
| | Calories/ | fl oz | fl oz |
| | fl oz | Ready-To- | Ready-To- |
| | Powder | Use | Use |
| (Normal Dilution) | (5 fl oz) | (5 fl oz) | (4.2 fl oz) |
| Protein, g | 2.8 | 2.8 | 2.8 |
| Fat, g | 5.6 | 5.6 | 5.6 |
| Linoleic acid, mg | 1040 | 1040 | 1040 |
| DHA, mg | 17 | 17 | 17 |
| ARA, mg | 34 | 34 | 34 |
| Carbohydrate, g | 10.2 | 10.2 | 10.2 |
| Water, g | 134 | 133 | 108 |
| Vitamin A, IU | 380 | 380 | 380 |
| Vitamin D, IU | 50 | 50 | 50 |
| Vitamin E, IU | 4 | 4 | 4 |
| Vitamin K, μg | 12 | 12 | 12 |
| Thiamin (Vitamin B1), μg | 80 | 80 | 80 |
| Riboflavin (Vitamin B2), | 90 | 90 | 90 |
| μg | | | |
| Vitamin B6, μg | 60 | 60 | 60 |
| Vitamin B12, μg | 0.3 | 0.3 | 0.3 |
| Niacin, μg | 1000 | 1000 | 1000 |
| Folic acid (folacin), μg | 16 | 16 | 16 |
| Pantothenic acid, μg | 500 | 500 | 500 |
| Biotin, μg | 3 | 3 | 3 |
| Vitamin C (ascorbic acid), | 12 | 12 | 12 |
| mg | | | |
| Choline, mg | 24 | 24 | 24 |
| Inositol, mg | 17 | 17 | 17 |
| Carnitine, mg | 2 | 2 | 2 |
| Taurine, mg | 6 | 6 | 6 |
| Calcium, mg | 94 | 94 | 94 |
| Phosphorus, mg | 52 | 52 | 52 |
| Magnesium, mg | 11 | 11 | 11 |
| Iron, mg | 1.8 | 1.8 | 1.8 |
| Zinc, mg | 1 | 1 | 1 |
| Manganese, μg | 25 | 25 | 25 |
| Copper, μg | 75 | 75 | 75 |
| Iodine, μg | 15 | 15 | 15 |
| Selenium, μg | 2.8 | 2.8 | 2.8 |
| Sodium, mg | 47 | 47 | 47 |
| Potassium, mg | 110 | 110 | 110 |
| Chloride, mg | 86 | 86 | 86 |

Table 7 illustrates the nutrient density of relevant components in the nutritional formulation of Example 3.

TABLE 7
Nutrient Facts

| Nutrient | 20 Calories/fl | 20 Calories/fl | 24 Calories/fl |
|---|---|---|---|
| Density | oz (Powder) | oz (Liquid) | oz (Liquid) |
| Protein | 11 | 11 | 11 |
| (% Calories) | | | |
| Fat (% Calories) | 47 | 47 | 47 |
| Carbohydrate | 42 | 42 | 42 |
| (% Calories) | | | |
| Potential Renal | 25 | 25 | 25 |
| Solute Load | | | |
| (mOsm/100 | | | |
| Calories)† | | | |
| Potential Renal | 16.8 | 16.8 | 20 |
| Solute Load | | | |
| (mOsm/100 mL)1 | | | |
| Osmolality | 290 | 290 | 340 |
| (mOsm/kg | | | |
| water) | | | |
| Osmolarity | 260 | 260 | 300 |
| (mOsm/L) | | | |

### EXAMPLE 4

This example illustrates a method for making the nutritional formulation of the invention. The fat blend and lipid oils were intermixed at 55° C. This fat blend mixture was then intermixed with water at 60° C., creating a base mix. Various minerals, such as potassium citrate, sodium citrate, potassium chloride, choline chloride, calcium hydroxide, carnitine, sodium iodide were then intermixed with water at 60° C. and added to the base mix. Calcium phosphate dibasic, calcium citrate and magnesium oxide were added to the base mix. Tapioca starch and corn syrup solids were added to the base mix.

The base mix was then subject to direct steam injection for about 25 seconds. The mixture was then flash cooled to 65° C. and homogenized and stored. Afterward, the mixture was filtered through a 1 mm filter. The filtered material was then heated to 80° C. and was spray dried to produce a powder. The powder had a moisture content of about 2% to 3%. The powder was then cooled, screened with a 2 mm screen, and packaged into 20 kg bags.

Variations on any of these manufacturing processes are known to or will be readily apparent to those skilled in the art. It is not intended that the invention be limited to any particular process of manufacture.

### EXAMPLE 5

This example illustrates the determination of the shelf-life of a nutritional formulation of the present invention. Accelerated conditions (higher temperatures and humidity) were used for informational purposes to determine the effects of adverse storage conditions on the product. Samples of the nutritional formulation of Example 1 were prepared and packaged. Samples were stored at 37±3° C. and 85% relative humidity (RH) for two weeks and then stored at room temperature (22±2° C. and 50% RH) for the remaining period of the study. This storage period simulated shipping and handling conditions. The samples were stored for 24 months and were then reviewed for quality assurance.

All stability results were acceptable. The powdered nutritional formulation was determined to have a shelf-life of at least 24 months and the reconstituted liquid nutritional formulation was determined to have a shelf-life of at least 18 months. Stability results were defined as satisfactory physical, chemical, and organoleptic properties as well as having nutrient levels within established limits. The samples met the minimal acceptable physical evaluation, which includes minimum or no gellation, sedimentation, fat serum, and grain presence in the product. There were no coagulations of the liquid or fat aggregations observed in the product. There were minimal or no changes in color and sensory attributes during the shelf life. Light and heat sensitive vitamins were at or above label claims during the shelf-life. Accordingly, the stability results were acceptable for the period specified.

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties to the extent that they do not contradict anything contained herein.

The discussion of the references herein is intended merely to summarize the assertions made by their authors and no admission is made that any reference constitutes prior art. Applicants reserve the right to challenge the accuracy and pertinence of the cited references.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of the various embodiments may be interchanged both in whole or in part.

What is claimed is:

1. A nutritional formulation comprising a lipid source, a carbohydrate source, a protein equivalent source, and an emulsifying agent comprising OSA-modified tapioca starch which contains less than about 0.05% non-protein nitrogen.

2. The nutritional formulation according to claim 1, wherein the nutritional formulation is protein-free.

3. The nutritional formulation according to claim 1, wherein the protein equivalent source is amino acids.

4. The nutritional formulation according to claim 1, wherein the protein equivalent source is hydrolyzed protein.

5. The nutritional formulation according to claim 4, wherein the protein is partially hydrolyzed.

6. The nutritional formulation according to claim 4, wherein the protein is extensively hydrolyzed.

7. The nutritional formulation according to claim 1, wherein the protein equivalent source is selected from the group consisting of soy protein, egg protein, whey protein and casein protein.

8. The nutritional formulation according to claim 1, wherein the protein equivalent source is intact protein.

9. The nutritional formulation according to claim 1, wherein the OSA-modified tapioca starch contains less than about 0.045% non-protein nitrogen.

10. The nutritional formulation according to claim 1, wherein the OSA-modified tapioca starch contains less than about 0.040% non-protein nitrogen.

11. The nutritional formulation according to claim 1, wherein the OSA-modified tapioca starch is protein-free.

12. The nutritional formulation according to claim 1, wherein OSA-modified tapioca starch is the sole emulsifying agent.

13. The nutritional formulation according to claim 1, wherein the OSA-modified tapioca starch is intact.

14. The nutritional formulation according to claim 1, wherein the nutritional formulation is hypoallergenic.

15. The nutritional formulation according to claim 1, wherein the pH of the nutritional formulation is between about 4 and 5.

16. The nutritional formulation according to claim 1, wherein the level of OSA-modified tapioca starch in the nutritional formulation comprises between about 2% and 15% of the formula.

17. The nutritional formulation according to claim 1, wherein the level of OSA-modified tapioca starch in the nutritional formulation comprises about 5% of the formula.

18. The nutritional formulation according to claim 17, wherein the OSA modified tapioca starch contributes 4% of the total caloric content.

19. The nutritional formulation according to claim 1, wherein the form of the nutritional formulation is selected from the group consisting of a liquid, a powder and a ready-to-use formulation.

20. The nutritional formulation according to claim 1 additionally comprising a source of DHA.

21. The nutritional formulation according to claim 20, wherein the source of DHA comprises single-celled organisms.

22. The nutritional formulation according to claim 20, wherein the nutritional formulation comprises DHA in an amount of from about 2 mg to about 100 mg per 100 kcal nutritional formulation.

23. The nutritional formulation according to claim 20, wherein the nutritional formulation comprises DHA in an amount of from about 5 mg to about 75 mg per 100 kcal nutritional formulation.

24. The nutritional formulation according to claim 20, wherein the nutritional formulation comprises DHA in an amount of from about 15 mg to about 60 mg per 100 kcal nutritional formulation.

25. The nutritional formulation according to claim 1 additionally comprising a source of DHA and a source of ARA.

26. The nutritional formulation according to claim 25, wherein the source of ARA comprises single-celled organisms.

27. The nutritional formulation according to claim 25, wherein the sources of both DHA and ARA comprise single-celled organisms.

28. The nutritional formulation according to claim 25, wherein the ratio of ARA:DHA in the nutritional formulation ranges from about 10:1 to about 1:10.

29. The nutritional formulation according to claim 25, wherein the ratio of ARA:DHA in the nutritional formulation ranges from about 2:1 to about 1:3.

30. The nutritional formulation according to claim 25, wherein the ratio of ARA:DHA in the nutritional formulation is about 1:2.

31. The nutritional formulation according to claim 25, wherein the nutritional formulation comprises ARA in an amount of from about 4 mg to about 100 mg per 100 kcal nutritional formulation.

32. The nutritional formulation according to claim 25, wherein the nutritional formulation comprises ARA in an amount of from about 10 mg to about 67 mg per 100 kcal nutritional formulation.

33. The nutritional formulation according to claim 25, wherein the nutritional formulation comprises ARA in an amount of from about 30 mg to about 40 mg per 100 kcal nutritional formulation.

34. The nutritional formulation according to claim 25, wherein the nutritional formulation contains substantially no EPA.

35. The nutritional formulation according to claim 1, wherein the nutritional formulation is an infant formula.

36. The nutritional formulation according to claim 1, wherein the nutritional formulation is a children's nutritional product.

37. A reconstituted nutritional formulation comprising a lipid source, a carbohydrate source, a protein equivalent source, and about 5% of an emulsifying agent comprising OSA-modified tapioca starch wherein the reconstituted nutritional formulation contains less than about 5 ppm non-protein nitrogen.

38. The nutritional formulation according to claim 37, wherein the reconstituted nutritional formulation contains less than about 4 ppm non-protein nitrogen.

39. The nutritional formulation according to claim 37, wherein the reconstituted nutritional formulation contains less than about 3.5 ppm non-protein nitrogen.

40. A method for treating a subject with protein allergies, the method comprising feeding the subject the nutritional formulation of claim 1.

41. The method according to claim 40, wherein the subject is an infant.

42. The method according to claim 40, wherein the subject is a child.

43. A method for treating a subject with protein intolerances, the method comprising feeding the subject the nutritional formulation of claim 1.

44. The method according to claim 43, wherein the subject is an infant.

45. The method according to claim 43, wherein the subject is a child.
